(19) United States
(12) Patent Application Publication
(10) Pub. No.: US 2020/0363127 A1
(43) Pub. Date: Nov. 19, 2020

(54) FERMENTATION RESIDUE CONDITIONER AND METHOD FOR CONDITIONING FERMENTATION RESIDUES

(71) Applicant: KOMPOFERM GmbH, Marienfeld (DE)

(72) Inventor: Karlgünter Eggersmann, Marienfeld (DE)

(73) Assignee: KOMPOFERM GmbH, Marienfeld (DE)

(21) Appl. No.: 16/985,628

(22) Filed: Aug. 5, 2020

Related U.S. Application Data
(63) Continuation-in-part of application No. 14/755,356, filed on Jun. 30, 2015, now abandoned.

(30) Foreign Application Priority Data
Aug. 11, 2014 (EP) 14002791.3

(51) Int. Cl. F26B 1/00; B65G 19/12; B65G 47/16; B65G 19/20; F26B 17/02; F26B 23/00; F26B 21/00

(52) U.S. Cl. CPC F26B 1/005; B65G 19/12; B65G 47/16; F26B 21/00; F26B 17/023; F26B 23/00; B65G 19/20

(57) ABSTRACT

A fermentation residue conditioner for conditioning aggregate materials consisting of fermentation residue, sludge, both of which having high water content, and/or organic residual masses with low water content, particularly of fermentation residues from the fermentation of household waste, bio-waste and/or base materials containing food residues, having a fermentation residue dropping point for introducing the aggregate material and a fermentation residue removal point for removing the aggregate material. The fermentation residue conditioner is designed such that the aggregate material is transportable through the fermentation residue conditioner during conditioning. The fermentation residue conditioner has a deposit surface for supporting the aggregate material from the underside, and wherein the aggregate material can be transported through the conditioner by a conveyor chain.

### CROSS REFERENCE TO RELATED APPLICATIONS

This patent application is a continuation-in-part application that claims the benefit of and priority under 35 USC § 120 to U.S. patent application Ser. No. 14/755,356 having a filing date of 30 Jun. 2015, which claims priority on European Patent Application No. 14002791.3 having a filing date of 11 Aug. 2014.

### BACKGROUND OF THE INVENTION

### Technical Field

The method relates to a fermentation residue conditioner and a method for conditioning fermentation residues or sludge with high water content and/or organic residual masses with low water content, particularly from the fermentation of household waste, bio-waste and/or base materials containing food residues.

### Prior Art

Fermentation residues and sludge accumulate, for example, in plants for producing biogas or sewage plants and, for their further treatment, e.g. by composting, have an unfavorable consistency, among others, and an excessive moisture content. This applies particularly to household waste, bio-waste, and/or base materials containing food residues. They have a very high energy content which makes them appear to be suitable for further processing, for example with fermentation processes with anaerobic fermentation and subsequent follow-up treatment, for example, subsequent composting. However, the consistency and the high moisture content of such base materials is disadvantageous.

For further processing, structural material that forms air pores and absorbs moisture, e.g. the screen overflow of composting, particularly bio-waste composting, and/or shredded organic waste, is frequently added to such base materials. The mixture of these materials is very frequently heterogeneous which prevents consistent ventilation.

In addition, such base materials, particularly household waste, bio-waste, and/or base materials having screening residues as structural material, contain impurities, for example, plastic films from garbage bags and/or meshes which should not find their way into the finished materials, for example, the compost or the deposit.

For these reasons, such base materials are conditioned for further processing, i.e. in particular, the moisture content is lowered, ammonia and/or methane are expelled, clumps are dissipated, and/or the base materials are homogenized.

### BRIEF SUMMARY OF THE INVENTION

Therefore, the invention addresses the problem of providing a fermentation residue conditioner for processing such base materials and a method for conditioning said base materials which both allow for an efficient conditioning of the fermentation residues while reducing the release of emissions.

The problem is solved by a fermentation residue conditioner and a method for conditioning fermentation residues or sludge according to the independent claims. The dependent claims relate to advantageous embodiments.

In the following, only the term “fermentation residues” will be used for the terms “fermentation residues” and “sludge” as well as for “organic residual masses with low water content, particularly fermentation residues from the fermentation of household waste, screening residues, and/or base materials containing food residues.” This also applies to the claims and serves as linguistic simplification.

The fermentation residue conditioner according to the invention comprises a deposit surface for fermentation residues which preferably extends in a first extension direction. The fermentation residues can be piled up on the deposit surface as aggregate material. The fermentation residue conditioner further comprises a fermentation residue dropping point and a fermentation residue removal point which is preferably spaced apart from the fermentation residue dropping point along the first extension direction.

At first, fermentation residue dropping point and fermentation residue removal point only denote the spatially determined regions in which the fermentation residues are dropped onto and removed from the fermentation residue conditioner. A specific design of these points can be advantageous but is basically not required. Therefore, fermentation residue dropping point and fermentation residue removal point do not necessarily have to differ structurally from the rest of the fermentation residue conditioner, particularly from other sections of the fermentation residue conditioner along the first extension direction.

According to the invention, transport can be effected by introducing forces in the underside of the aggregate material, which is formed by the fermentation residue and deposited on a deposit surface.

The aggregate material is to be understood to be aggregate material in the broadest sense; in particular, the term also includes very wet materials, such as sludge, i.e. materials from compact to porous consistency as well as very heterogeneous materials, particularly with clumps and/or regions discreetly separated by planar formations, for example regions encased or separated from one another by plastic films which, for example, are caused by garbage bags.

For the sake of linguistic simplicity, in the following, the spatial arrangements of the aforementioned base materials in the fermentation residue conditioner according to the invention and for the execution of the method according to the invention will be generally called aggregate materials, even if they have a consistency which is not typical for aggregate material in the narrower sense of the word. This also applies to the use of the term aggregate material in the claims.

The application of force from the underside onto the aggregate material allows for it to be transported through the fermentation residue conditioner, whereby the inner structure of said aggregate material is not crucial. As a result, the most diverse materials can be transported without problem. Furthermore, the transport does not depend on a possible shifting or homogenization, i.e. it is possible to provide appropriate means for shifting or homogenizing the aggregate material and to adjust said means to the aggregate material such that the shifting is effected with regard to the protection of plastic films and similar impurities.

This prevents the impurities from being shredded and allocated to the incorrect fraction during subsequent separation processes or from not being separated at all. In this regard, the application of force from the underside is also particularly advantageous because it is not accompanied by a penetration of the aggregate material itself and thus is also protective of material with regard to the shredding of possible impurities.

In one embodiment, the deposit surface has back-and-forth movable deposit elements for supporting the aggregate material. They are particularly designed such that a closed, preferably also liquid-tight deposit surface for the aggregate material is always formed. A plurality of deposit surfaces is provided particularly in the direction perpendicular to the transport direction and/or perpendicular to the direction of movement of the deposit elements. If these deposit elements are suitably controlled in their movement, the deposit elements can effect a transport of the aggregate material deposited on the deposit elements by their back and forth movement, for example, by moving the deposit elements individually in the opposite direction of the transport direction and then together in transport direction, and so the aggregate material deposited on the deposit elements substantially only follows the movement in transport direction. Correspondingly, it is also possible for the deposit elements to be moved in groups as long as the desired transport effect is achieved. Such a design of the deposit surface is routinely called a “walking floor.” This “walking floor” is achieved with the deposit elements made from metal as described herein in addition to a plurality of conveyor chains.

In a preferred embodiment, the transport of the aggregate material is achieved by at least one conveyor chain. Each conveyor chain also may include a plurality of transport elements, which can be, for example, a thin wire comb/wire mesh structure, or a scraper-type structure. It has become apparent that, if such a transport element is designed to be sufficiently flat, such a transport element also only allows for the introduction of the movement force on the underside of the aggregate material in accordance with the invention.

It has become apparent that the desired effect, i.e. introduction of the force causing the movement while the conveyor chains are traveling in the transport direction, can be achieved with such movable transport elements coupled to a respective conveyor chain without noticeably disadvantageous penetration of the aggregate material if the part of the transport elements that protrudes into the aggregate material and directly causes the transport does not protrude into the aggregate material by more than 60 mm, preferably no more than 40 mm, and more preferably up to 15 mm, from the deposit surface.

The part that does not directly cause the transport is the part of a movable transport element which does not apply force directly to the underside of the aggregate material at an appropriate time point. It is understood that, for example within the course of the return of a rotating movable transport element, said transport element, for example, can be guided back on the ends of the fermentation residue conditioner upward or downward out of and over and below the fermentation residue conditioner in order to create a continuous loop, which is formed by a respective conveyor chain of a plurality of conveyor chains. It is understood that such a part of the transport element which is guided away from the deposit surface is not to be considered to be a part of the movable transport element which directly effects transport.

As described herein, the deposit surface may comprise a plurality of deposit elements which may comprise movable cylinders. Meanwhile, a plurality of conveyor chains may move over the plurality of deposit elements or the deposit surface. Each conveyor chain also may have its own transport elements which protrude into the aggregate material. If deposit elements are used, the deposit elements are preferably arranged so as to be oriented with their greatest extension (i.e. length) direction in the transport direction and which is the same direction in which the preferred embodiment conveyor chain moves.

Preferably, the deposit surface underneath the conveyor chains and supporting the aggregate material in between the conveyor chains are made of metal.

The fermentation residue conditioner according to the invention is preferably designed so as to be heat-insulated for optimizing the thermal efficiency due to heat losses to the atmosphere and thus recondensation.

The fermentation residue conditioner furthermore preferably has a shifting and decompacting unit. This shifting and decompacting unit is suitable and designed to shift and homogenize the fermentation residues located on the deposit surface when used as intended, break up clumps, form new surfaces, cause a mixing of the fermentation residue and/or support the transport of the fermentation residue along the first extension direction.

Preferably, the method according to the invention provides for the aggregate material to be deposited on a fermentation residue conditioner in the region of the fermentation residue dropping point, and the aggregate material is removed from the fermentation residue conditioner in the region of the fermentation residue removal point which is spaced apart from the fermentation residue dropping point along the first extension direction of a deposit surface for the aggregate material of the fermentation residue conditioner. The aggregate material is transported from the fermentation residue dropping point to the fermentation residue removal point along the first extension direction across the deposit surface.

It is advantageous if the shifting and decompacting unit acts on the fermentation residues simultaneously only on a partial section of the entire extension of the deposit surface along the first extension direction between fermentation residue dropping point and fermentation residue removal point. In this way, the shifting and decompacting unit, which only extends over a partial section of the aforementioned entire extension, can be designed so as to be structurally smaller, thus saving more material and costs than a shifting and decompacting unit which would act on the entire amount of fermentation residue and would thus have to extend over the entire deposit surface.

This advantage is based on the realization that, with regard to the conditioning process, it suffices if only a part of the fermentation residues is simultaneously shifted at a time because the drying processes in particular take up a certain amount of time. Multiple shifting, which is used to homogenize the fermentation residue mass and particularly to break up clumps, only requires a fraction of the time needed for the entire conditioning process.

This is made possible particularly by a shifting and decompacting unit which has a rotating shifting body. By means of this shifting body, which preferably rotates around an axis which is horizontal and/or runs at a right angle to the first extension direction, the shifting and decompacting unit acts on the fermentation residues. The shifting body can cause a shifting but also support the transport by the fermentation residue conditioner, wherein it is particularly advantageous if the rotational direction of the shifting body is selected such that its upper apex moves in the direction of the fermentation residue removal point.

Furthermore, due to this shifting during multiple shiftings, a fermentation residue clump is gradually broken up such that the outer already dried material falls off and the still wet material below is dried further, wherein said process is repeated. In addition, clumps are split, and so larger surfaces are provided for drying. An apex is also understood to be an apex line which forms particularly with a shifting body designed so as to be cylindrical.

In order to make it possible that the shifting and decompacting unit can act, if not simultaneously then at least time-delayed, on all regions of the aggregate material on the deposit surface, it is advantageous if the shifting and decompacting unit is movable along the first extension direction. According to another embodiment, the shifting and decompacting unit may be arranged such that it constitutes a swivel element that can be moved like a pendulum inside the aggregate material. The axis of rotation then runs perpendicular to the first extension direction. Preferably, the free end of this pendulum can move between 0-50 cm.

For example, this can be achieved with guides, e.g. a rail system, extending along the first extension direction. The guides are located advantageously above the aggregate material height resulting from the intended use of the fermentation residue conditioner and/or outside the fermentation residue conditioner. It is thus ensured that the function of the guides for the shifting and decompacting unit is not affected by fermentation residues.

It is advantageous to execute the method such that it results in an aggregate material height of the aggregate material from 10 to 150 cm, particularly from 60 to 100 cm. This aggregate material height results in a drying speed at which the advantages of the present invention can be used efficiently.

It is meaningful to accommodate the shifting and decompacting unit on the fermentation residue conditioner, preferably on the guides, by means of a distance adjustment unit. The distance adjustment unit is used to change the distance of the shifting and decompacting unit to the deposit surface and can, for example, be realized by means of a swivel element. In this way, the shifting and decompacting unit can move upward and avoid hard objects which are possibly located under the fermentation residues, thus effectively preventing damage to the shifting and decompacting unit and the deposit surface by the hard objects when they get between the shifting and decompacting unit and the deposit surface, and making the return travel possible.

It is furthermore advantageous if the deposit surface has a heating unit which makes a direct heat transfer to the aggregate material possible by heat conduction. By means of the heating unit, it is possible to heat the aggregate material which accelerates the drying of the aggregate material. The interaction of a heated deposit surface with a shifting and decompacting unit is particularly advantageous because with every shifting, a new surface of the fermentation residues comes in contact with the heated deposit surface, thus resulting overall in a homogeneous and accelerated drying process. The direct heating is performed between the deposit surface and the aggregate material. The conveyor chain is actually not important with respect to the heat transfer. The purpose of the conveyor chain is to move the transport elements (protruding elements like scrapers or the like).

It is further advantageous if the deposit surface has a ventilation unit for ventilating the aggregate material. Ventilating the aggregate material ensures a faster moisture transport and also heat influx into the aggregate material, particularly with preheated air. It is particularly advantageous that clumps, so-called microbatches, are broken up through homogenization, and so the ventilation can also reach the moisture stored within these clumps and does not flow around said clumps.

The ventilation unit and/or the heating unit is segmented preferably along the first extension direction. In other words, a ventilation unit and/or a heating unit are each associated with individual sections of the first extension direction of the fermentation residue conditioner. It is also possible to provide a heating unit and/or a ventilation unit with a plurality of redundant elements, for example a plurality of supply or return and/or supply air or exhaust air lines or circuits, wherein the redundant elements are each associated with individual sections along the longitudinal extension of the fermentation residue conditioner.

Preferably, a system consisting of a plurality of fermentation residue conditioners is provided. The plurality of fermentation residue conditioners can be parallel- and/or series-connected. Preferred is a variation in which a plurality of fermentation residue conditioners, for reasons of installation space, is arranged spatially one above the other.

The described fermentation residue conditioner not only offers the possibility of drying fermentation residues thermally but particularly constitutes a preliminary stage for an optimized start of a subsequent aerobic treatment of the fermentation residues.

By means of the described fermentation residue conditioner, ammonia, which is present in the fermentation residues and toxic for an aerobic process, is effectively expelled and securely contained by means of preheated air. For securely containing the exhaust air and/or reduction of emissions, the fermentation residue conditioner is preferably designed such that gaseous emissions are prevented and/or at least avoided to a great extent. In particular, the fermentation residue conditioner is designed so as to be encapsulated. The concentrated exhaust air flows can be fed to an appropriate exhaust air treatment, e.g. an acid washer.

The treatment of the fermentation residues by means of the described fermentation residue conditioner releases methane contained in the fermentation residues through the airflow. Particularly with regard to the possibility of expelling ammonia and/or methane from the fermentation residue, it is advantageous if the fermentation residue conditioner is designed such that it is possible to guide the air for ventilating the fermentation residues at least to some extent in the circuit.

It is preferably possible to control the ratio of the air guided in the circuit to the supplied and/or discharged air. This way, it is possible to increase the heat influx and/or the loading of the discharged air with ammonia and/or methane. This is advantageous because with a downstream exhaust air treatment, a smaller air volume has to be treated. It is particularly advantageous if the control range of the ratio covers the borderline cases of clean circulation and/or clean fresh-air ventilation.

In addition, due to the mechanical components of the described fermentation residue conditioner (loosening, macerating, and/or homogenizing), a forming of methane within the fermentation residue clumps or the like is significantly reduced or prevented and the release of climate-relevant methane into the atmosphere in downstream processes is significantly reduced.

With an optimized systemization/control of the shifting and decompacting unit, it is possible to adjust volume and dumping height losses of the fermentation residue due to, e.g. the reduction of organic mass and/or increased fine-grain formation through processing. In addition to adjusting the dumping height of the fermentation residues, the dumping height during treatment and thus the dwell time of the fermentation residues within the fermentation residue conditioner can further be increased. This results in a reduction of investment and thus treatment costs.

### BRIEF DESCRIPTION OF THE DRAWINGS

In the following, the invention is described in more detail using FIGS. 1 to 7.

FIG. 1A shows a schematic depiction of an exemplary fermentation residue conditioner according to the invention;

FIG. 1B shows an enlarged view of a section of the fermentation conditioner of FIG. 1A;

FIG. 2 shows a cross-section of an exemplary fermentation residue conditioner according to the invention with sectional plane running at a right angle to the transport direction, illustrating an air guiding system;

FIG. 3 shows another view similar to FIG. 2 illustrating a heating system;

FIG. 4 shows a detailed elevational view of a deposit surface without the transport elements and aggregate visible for the fermentation residue conditioner according to the invention;

FIG. 5 shows detailed side views of individual deposit elements of an exemplary fermentation residue conditioner according to the invention;

FIG. 6A shows a detailed, elevational view of the deposit surface, similar to FIG. 4A, but with the transport elements of each conveyor chain visible for the fermentation residue conditioner according to the invention;

FIG. 6B shows an enlarged, perspective view of the deposit surface with both the transport elements and the deposit elements visible for the fermentation residue conditioner according to the invention;

FIG. 6C shows a geometry of a transport element according to an exemplary embodiment;

FIG. 6D shows a functional block diagram illustrating direct heat conduction between the deposit elements, transport elements and/or conveyor chain, and the aggregate material according to an exemplary embodiment;

FIG. 6E shows a functional block diagram illustrating direct heat conduction between the deposit elements (existing between conveyor chains) and the aggregate material according to an exemplary embodiment;

FIG. 7A shows an enlarged view of a section of the fermentation conditioner of FIG. 1A showing the fermentation residue removal point on the right end of the fermentation conditioner;

FIG. 7B shows an enlarged view of a section of the fermentation conditioner of FIG. 1A showing the fermentation residue dropping point on the left end of the fermentation conditioner;

FIG. 7C shows a top view of aggregate material on the deposit surface, with transport elements;

FIG. 7D shows a side cross sectional view aggregate material on the deposit surface, with transport elements, along line A of FIG. 7C;

FIG. 7E shows a side cross sectional view similar to FIG. 7D and incorporating a pendulum embodiment of a shifting and decompacting unit, with the transport direction across the page; and

FIG. 7F shows an end cross sectional view of FIG. 7D also incorporating a pendulum embodiment of a shifting and decompacting unit, with the transport direction into or out of the page.

### DETAILED DESCRIPTION OF PREFERRED EMBODIMENTS

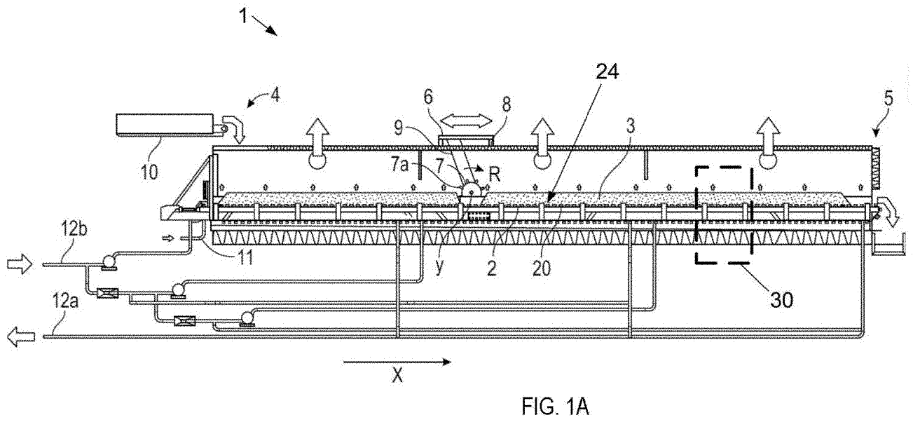

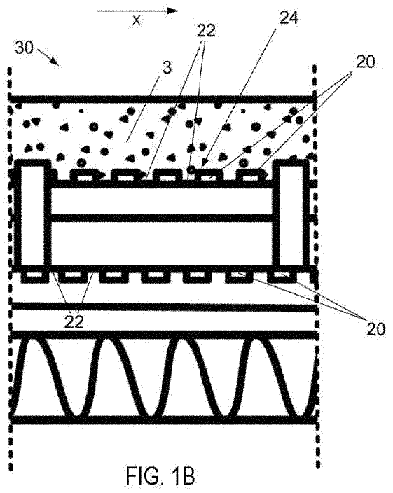

Referring now to FIG. 1A, the exemplary fermentation residue conditioner 1 according to the invention has a deposit surface 2 for the aggregate material 3. The fermentation residues form the aggregate material 3 on the deposit surface 2 and are deposited at the fermentation residue dropping point 4, e.g. by a first conveyor 10, onto the deposit surface 2.

The deposit surface 2 supports the aggregate material 3. Transport elements 20 are used to move the aggregate material 3. The chain links 22 are part of a conveyor chain 24. A conveyor chain 24 is a chain that has been designed specifically for chain conveyor systems, as understood by one of ordinary skill in the art. The conveyor chain 24 effects the movement of transport elements 20.

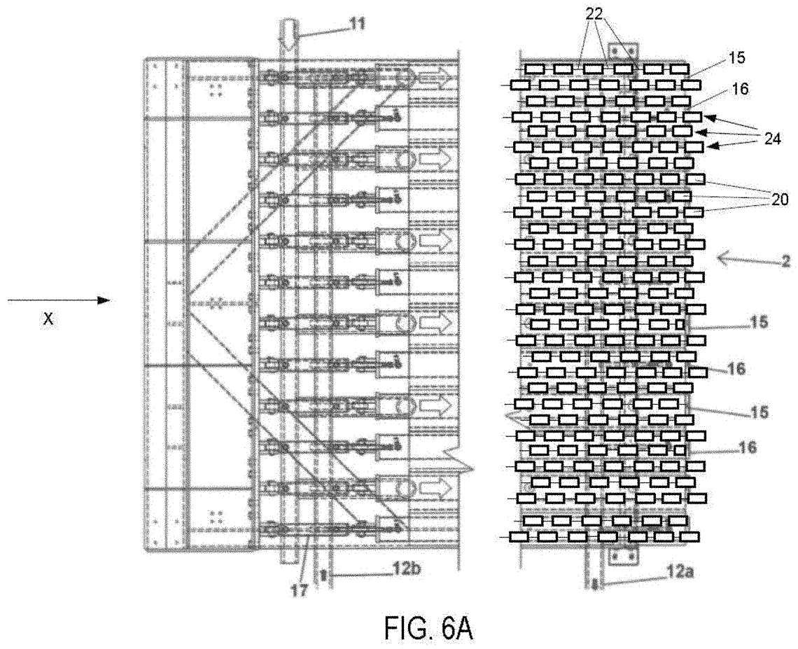

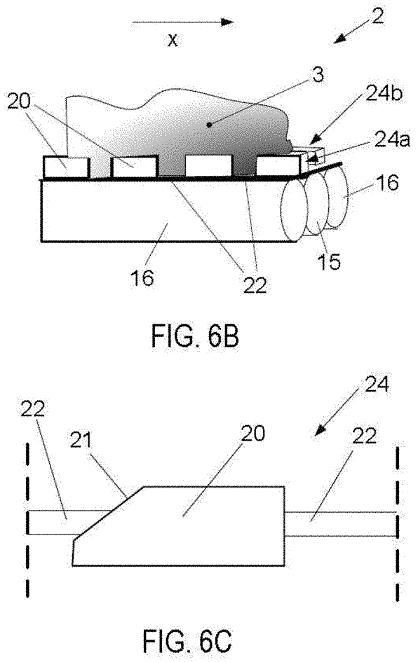

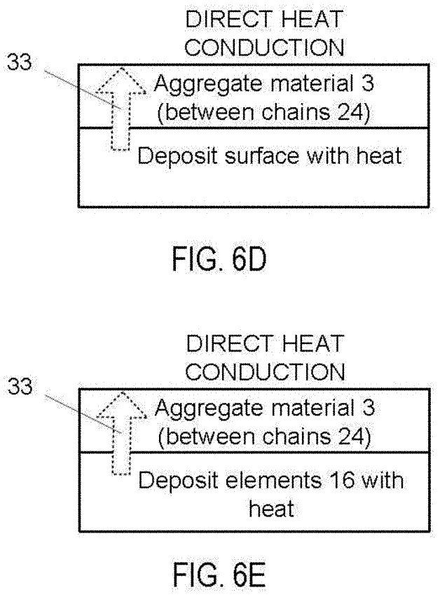

Thus, the chain links 22 and transport elements 20 form a complete conveyor chain 24 according to an exemplary embodiment. The conveyor chain 24 rotates clockwise on the page as shown in FIG. 1A. The chain links 22 and transport elements 20 will be described in further detail herein. Further, as will described in detail below, a plurality of conveyor chains 24 may be employed across the deposit elements 15, 16 as illustrated in FIG. 6A.

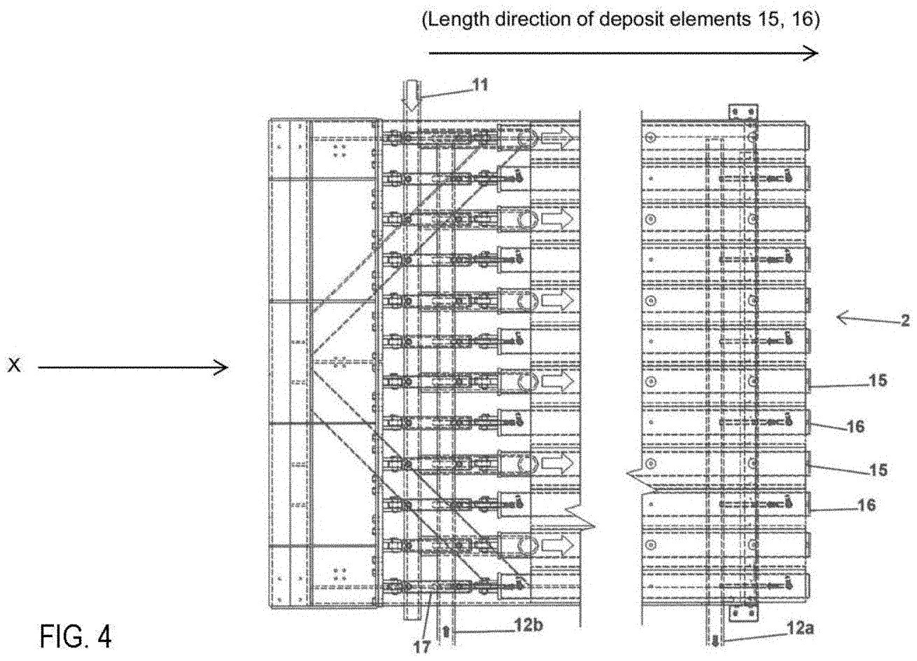

The transport of the aggregate material 3 to the fermentation residue removal point 5 according to the invention is effected by the design of the deposit surface 2 and the transport element(s) 20 moved by the conveyor chain 24. In the depicted example, the deposit surface 2 could as an alternative to a conveyor chain 24 have back-and-forth movable deposit elements 15 and 16, each associated with a drive element, for example hydraulics 17 (see FIGS. 4 and 6A), for moving the deposit elements 15 and 16 back and forth.

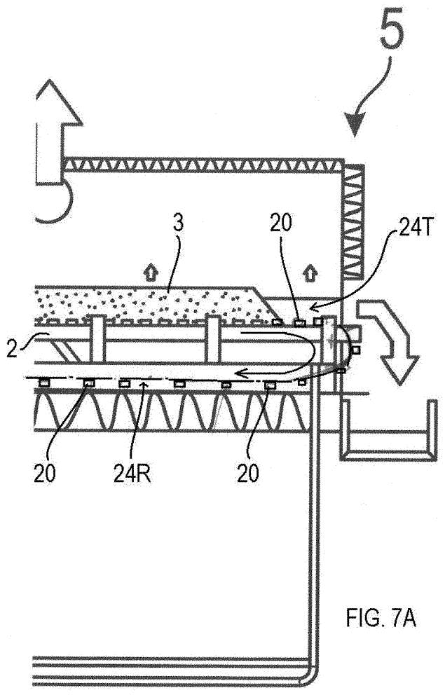

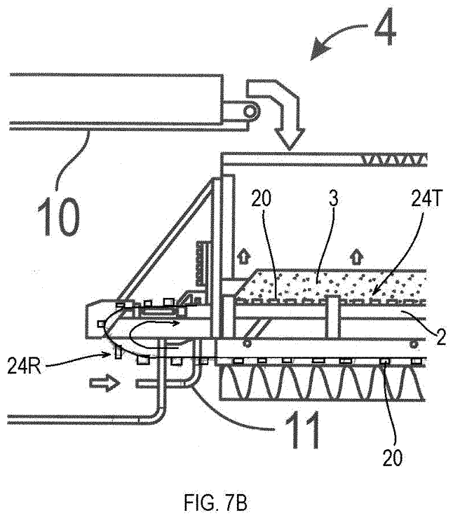

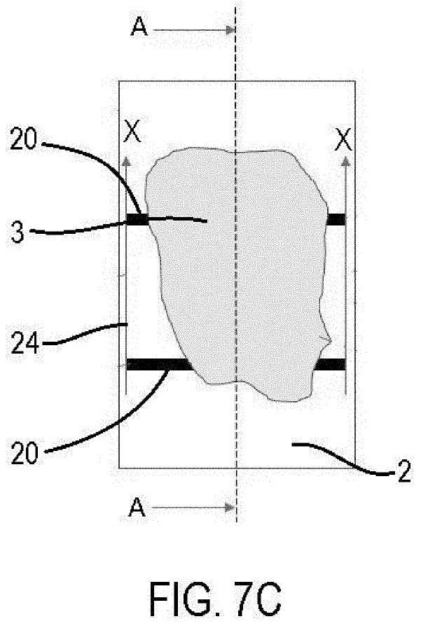

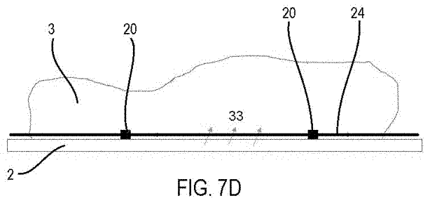

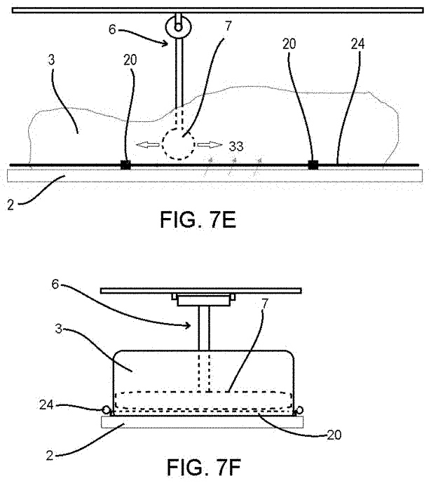

Further, in the depicted example of FIG. 1A, the transport element(s) 20 are movable relative to the deposit surface 2, and relative to the floor surface underlying the entire fermentation residue conditioner 1. The transport element(s) 20 are arranged next to one another and spaced apart in the transport direction X, and configured in the form of a continuous loop system referred to as the conveyor chain 24 (see also FIGS. 7A and 7B).

During the course of a return of the conveyor chain 24 having the spaced transport element(s) 20, the transport element(s) 20, in aggregate, are sufficiently flat to allow for the introduction of a movement force on the underside of the aggregate material 3. The transport element(s) 20, protrude into the aggregate material 3 by no more than 60 mm, preferably 40 mm, from the underlying and supporting deposit surface 2 (See also FIG. 7D).

As defined in this disclosure, the transport element(s) 20 have a definitive height quantity/magnitude relative to the deposit surface 2, which may be the surface of one of the deposit elements 15, 16. This means that transport element(s) 20 must have a height dimension amount greater than zero in order to protrude into the aggregate material 3. According to one exemplary embodiment, the transport elements 20 may comprise scrapers made from metal (see FIGS. 7C and 7D).

The shifting and decompacting unit 6, which is preferably accommodated along a rail system 8 which is arranged above the aggregate material height of the fermentation residues and/or outside of the fermentation residue conditioner, can, by means of a shifting body 7, which rotates in rotation direction R, contact, engage and/or penetrate the fermentation residues which are thus shifted, loosened, and broken up.

The shifting body 7 may be designed as a roller which rotates around the axis Y, and has protrusions 7a. The shifting body 7 with protrusions 7a provide the roller with a profile, that engages and/or penetrates the fermentation residues 3. The shifting body 7 with protrusions 7a may homogenize, break up, and loosen the fermentation residues 3 and thus dry them faster.

The floor of the fermentation residue conditioner 1 preferably has a heating unit 12 and/or a ventilation unit 11 below in direct contact with or in the deposit surface 2. The heating unit 12 has channels through which a heating medium can flow and which run horizontally below the deposit surface 2. The channels are each connected to a supply line 12b and a return line 12a for the heating medium, which are supplied with heating medium by means of a common return line, wherein the heating medium can also be discharged again by means of a common return line.

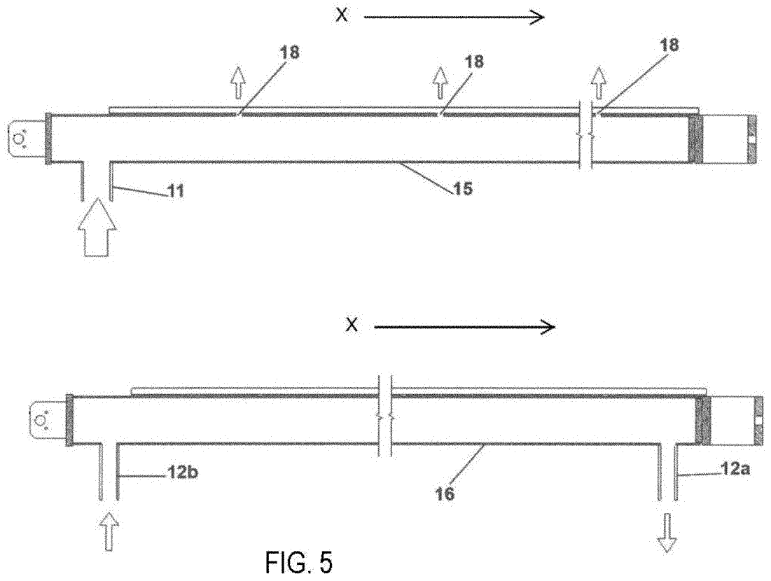

Of course, a plurality of heating circuits with a corresponding plurality of supply lines or return lines can also be provided. In the depicted example in FIG. 1, three such heating circuits are associated with individual sections along the first extension direction X of the fermentation residue conditioner 1. In the depicted example, the deposit elements 16 (see FIG. 5) advantageously form the channels through which the heating medium flows.

The fermentation residue conditioner according to the invention can advantageously also have a ventilation unit 11. In the depicted example, it is realized such that the deposit elements 15 (see FIG. 5) are provided with air outlet openings 18 and supplied with supply air by means of the ventilation unit 11. The supply air flows out of the air outlet openings 18 and enters into the aggregate material.

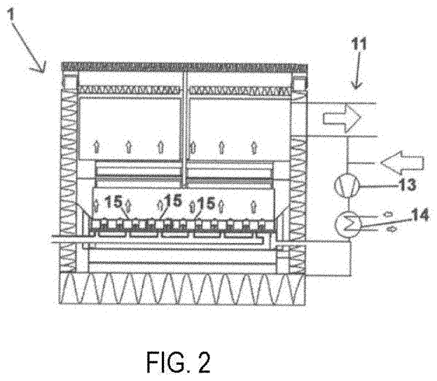

Referring now to FIG. 2, this figure shows a corresponding ventilation unit 11. In a width direction of the exemplarily depicted fermentation residue conditioner, every other deposit element 15 is supplied by the ventilation unit 11. The transport unit 13 and a first heating unit 14 are also illustrated in this figure.

In the example depicted in FIG. 2, the air is transported by a transport unit 13. According to one exemplary embodiment, the transport unit 13 may comprise a compressor. In the depicted example, the ventilation unit 11 is designed such that some of the air can be guided in the circuit. The transport unit 13 can be supplied with a mixture with any ratio of supply air and exhaust air which are extracted from the fermentation residue conditioner 1.

Furthermore, the first heating unit 14 is provided for supply air for the fermentation residue conditioner which is advantageous because, with air flow, additional heat can be introduced to the aggregate material 3 comprising the fermentation residues.

In addition, the warm air from the first heating unit 14 can absorb and discharge a greater quantity of moisture from the aggregate material 3 comprising the fermentation residues. Particularly, in case of fermentation residue and sludge, ammonia that is contained therein may be securely expelled by means of the ventilation unit 11 and deposit elements 15. Furthermore, due to the breaking up of fermentation residue clumps, possible fermentation processes or anaerobic processes which produce methane, that could be occurring within clumps while they are traveling through the fermentation residue conditioner 1, can be safely terminated/stopped.

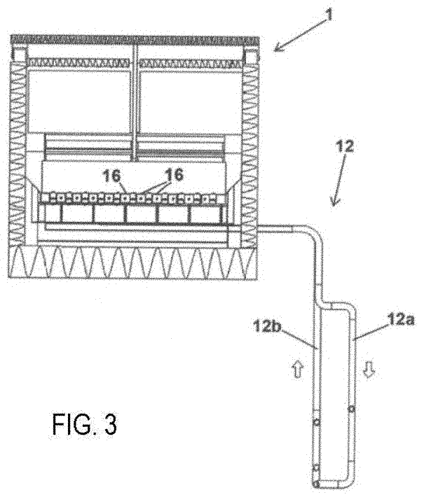

Referring now to FIG. 3, this figure shows the cross-section of an exemplary fermentation residue conditioner according to the invention, in which every other deposit element 16 is supplied with a heating medium by a second heating unit 12. Of course, it is also possible and particularly advantageous if a single fermentation residue conditioner according to the invention has deposit elements 15 which are supplied with air by means of a ventilation unit 11 and deposit elements 16 which are supplied with a heating medium by the second heating unit 12. As a result, they can alternate, advantageously individually or in groups, in width direction of the fermentation residue conditioner according to the invention, i.e. perpendicular to the transport direction X of the fermentation residue conditioner

Referring now to FIG. 4, this figure shows a detailed elevational view of a deposit surface 2 without the transport elements 20 and aggregate material 3 visible for the fermentation residue conditioner according to the invention. In this view, the hydraulics 17 which can move each deposit element 15, 16 back and forth along the transport direction X are visible. As noted previously, the deposit element 15 may ventilate the aggregate material 3, while the deposit element 16 may heat the aggregate material 3 (not visible) through direct heat conduction. The hydraulics 17 may move each deposit element 15, 16 back and forth along the transport direction X. That is, the hydraulics 17 may translate each deposit element 15, 16 back and forth along the transport direction, as explained previously. The direct heating is performed between the deposit surface 2 and the aggregate material 3.

Referring now to FIG. 5, this figure shows detailed side views of individual deposit elements 15, 16 of an exemplary fermentation residue conditioner according to the invention. As noted previously, the deposit element 15 may provide ventilation to the aggregate material 3 (not visible in this figure) by using air outlet openings 18. Meanwhile, deposit element 16 may provide heat to the aggregate material 3 (not visible in this figure) by direct heat conduction by heating the aggregate material 3 that rests on the deposit surface 2, the aggregate material 3 being moved by conveyor chain 24 (not visible in this figure).

Referring now to FIG. 6A, this figure shows a detailed, elevational view of the deposit surface 2, similar to FIG. 4A, but with one embodiment of the transport elements 20 of each conveyor chain 24 visible for the fermentation residue conditioner according to the invention. In this FIG. 6A, transport elements 20, as well as the chain links 22 between the transport elements 22, are visible. The transport elements 20 and chain links 22 form each conveyor chain 24 of a plurality of conveyor chains 24 shown. The plurality of conveyor chains 24, like the deposit elements 15, 16, are only shown in sections in FIG. 6A.

FIG. 6A also shows how transport elements 20 maybe positioned in an offset manner relative to the transport direction X. According to other exemplary embodiments (see FIGS. 7A, 7B, 7C, and 7D), the transport elements 20 may be positioned such they are substantially aligned in the transport direction X. As shown in FIG. 6A, the transport elements 20 may be substantially aligned in a direction perpendicular to the transport direction X. However, in other exemplary embodiments (not shown), the transport elements 20 may be offset relative to each other in a direction perpendicular to the transport direction X.

Referring now to FIG. 6B, this figure shows an enlarged, perspective view of the deposit surface 2. The deposit surface 2 may comprise the transport elements 20, chain links 22, deposit elements 15, 16, and gaps (spaces) between the conveyor chains 24, all for effecting the movement of the aggregate material 3. This figure shows how there is direct physical contact between the deposit elements 16 that generate heat and the aggregate material 3 that sits between conveyor chains 24a, and 24b as well as aggregate material 3 supported by each conveyor chain 24a, 24b that includes the transport elements 20 and chain links 22. The figure also shows the direct physical contact (i.e. no air gaps) between the deposit surface 15, 16 and the aggregate material 3. As mentioned previously, the direct heating is performed between the deposit surface 2 and the aggregate material 3. The chain 24 is actually not important with respect to the heat transfer as the purpose of the chain 24 is to move the transport elements 20.

Referring now to FIG. 6C, this figure illustrates a geometry of a transport element 20 according to an exemplary embodiment. Adjacent on either side of the transport element 20 is a respective chain link 22. As noted above, the transport elements 20 and chain links 22 form a respective conveyor chain 24 as understood by one of ordinary skill in the art. According to the exemplary embodiment shown in FIG. 6B, the transport element 20 may comprise an angled side 21, while the remaining sides may comprise a substantially rectangular shape. Other geometries for the transport elements 20 are possible and are included within the scope of this disclosure as understood by one of ordinary skill in the art.

Referring now to FIG. 6D, this figure shows a functional block diagram illustrating direct heat conduction 33 between the deposit surface 16, transport elements 20, and the aggregate material 3 according to an exemplary embodiment. The direct heat conduction 33 may occur as there are no air gaps between the physical elements depicted in this schematic. Although there may be direct contact between the conveyor chain 24 and the deposit surface 2, the direct heating is performed between the deposit surface 2 and the aggregate material 3 and the chain 24 is not important with respect to the heat transfer. The purpose of the chain 24 is to move the transport elements 20 (protruding elements like scrapers or the like). In light of this, the deposit elements 16 heat the aggregate material 3 through direct conduction, which equates to transferring heat directly through objects and without any of the heat being conveyed through the air or other contact-less heat transfer as understood by one of ordinary skill in the art.

Referring now to FIG. 6E, this figure shows a functional block diagram illustrating direct heat conduction between the deposit elements 16 (existing between conveyor chains 24) and the aggregate material 3 according to an exemplary embodiment. The deposit elements 16 may generate heat, as described above, and through direct physical contact (without any air gaps), the elements 16 may transfer heat by direct heat conduction indicated by arrow 33 into the aggregate material 3.

Referring now to FIG. 7A, this figure shows an enlarged view of a section of the fermentation conditioner of FIG. 1A showing the fermentation residue removal point 5 on the right end of the fermentation conditioner. FIG. 7A shows greater detail of the chain 24, showing the chain 24T above the deposit surface 2 transporting aggregate material 3 in the transport direction X for removing aggregate material 3 from the fermentation conditioner, and the chain 24R below the deposit surface 2 returning in a loop-like fashion. Transport portion 24T shows transport elements 20, for the most part, contacting aggregate material 3 and moving aggregate material 3 in the transport direction. Return portion 24R does not contact the aggregate material 3.

Referring now to FIG. 7B, this figure shows an enlarged view of a section of the fermentation conditioner of FIG. 1A showing the fermentation residue dropping point 4 on the left end of the fermentation conditioner. FIG. 7B also shows greater detail of the chain 24, showing the chain 24T above the deposit surface 2 for accepting aggregate material 3 and transporting aggregate material 3 in the transport direction X, and the chain 24R below the deposit surface 2 returning in a loop-like fashion. Transport portion 24T shows transport elements 20, for the most part, contacting aggregate material 3 and moving aggregate material 3 in the transport direction. Return portion 24R does not contact the aggregate material 3 until looping to a position above the deposit surface 2 proximal to dropping point 4.

Referring now to FIG. 7C, this figure shows a top view of aggregate material 3 on the deposit surface 2. More specifically, aggregate material 3 is shown lying on an embodiment of transport elements 20 that extend across the deposit surface 2 perpendicular to the transport direction X. Chain 24 is shown as connecting a plurality of transport elements 20 for moving in transport direction X. In this embodiment of transport elements 20, transport elements 20 are arranged parallel to one another, perpendicular to the transport direction, and spaced apart, and configured in the form of a continuous loop system as the conveyor chain 24. As disclosed previously, the deposit surface 3 on which the aggregate material 3 rests is heated such that heat conduction goes directly from the heated deposit surface 2 into the aggregate material 3.

Referring now to FIG. 7D, this figure shows a side cross sectional view of aggregate material 3 on the deposit surface 2, with transport elements 20, along line A of FIG. 7C. The transport elements 20 are shown protruding into the aggregate material 3. As disclosed previously, the transport elements protrude into the aggregate material 3 by no more than 60 mm, and preferably no more than 40 mm, and more preferably at least 10 mm to 15 mm from the underlying and supporting deposit surface 2. Transport elements 20 have a height dimension amount greater than zero in order to protrude into the aggregate material 3. In the embodiment shown in this figure, transport elements 20 are in the general form of scrapers for moving the aggregate material 3 along the deposit surface 2. The three parallel angles arrows represent heat conduction 33 going directly from the heated deposit surface 2 into the aggregate material 3 as well as air flow going directly from the deposit surface into the aggregate material 3.

Referring now to FIG. 7E, this figure shows a side cross sectional view similar to FIG. 7D and incorporating a pendulum embodiment of a shifting and decompacting unit 6, with the transport direction X from across the page. The shifting and decompacting unit 6 swings through the aggregate material 3 in a direction parallel to the transport direction X, and exemplified by the two arrows showing the back and forth motion of the shifting and decompacting unit 6. The shifting and decompacting unit 6 can be attached to a roof of the fermentation residue conditioner 1 and can comprise a motor (not shown) for imparting the pendulum motion.

Referring now to FIG. 7F, this figure shows an end cross sectional view of FIG. 7D also incorporating a pendulum embodiment of a shifting and decompacting unit 6, with the transport direction X into or out of the page. The shifting and decompacting unit 6 swings through the aggregate material 3 in a direction parallel to the transport direction X, and the width of the shifting and compacting unit 6 can be any width up to a width as wide as the width of the deposit surface 6 so as to be able to contact most if not all of the width of the aggregate material 3 on the deposit surface 2.

What is claimed is:

1. A fermentation residue conditioner for conditioning an aggregate material consisting of at least one of a fermentation residue with high water content, a sludge with high water content, and an organic residual mass with low water content, the fermentation residue conditioner defining a fermentation residue dropping point for introducing the aggregate material, and a fermentation residue removal point for removing the aggregate material, the fermentation residue conditioner configured to transport the aggregate material through the fermentation residue conditioner, the fermentation residue conditioner comprising:
a ventilation unit;
a conveyor chain
a deposit surface for supporting the aggregate material from the underside;
a heating unit for heating the aggregate material supported by the deposit surface, the heating unit in thermal communication with the deposit surface for direct heat conduction to the aggregate material;
a transport element attached to the conveyor chain, configured for engaging the aggregate material and moving the aggregate material in a transport direction (X) relative to the deposit surface, and configured such that the transport element protrudes into the aggregate material a distance no more than 60 mm relative to the deposit surface; and
a shifting and decompacting unit for at least one of shifting, loosening, macerating, and homogenizing the aggregate material supported by the deposit surface and transported through the fermentation residue conditioner via the conveyor chain.

2. The fermentation residue conditioner according to claim 1, wherein the conveyor chain comprises a plurality of transport elements, wherein gaps are present between respective transport elements.

4. The fermentation residue conditioner according to claim 1, wherein the shifting and decompacting unit has a rotating shifting body that rotates around an axis (Y) that is horizontal and/or runs at a right angle to the transport direction (X).

5. The fermentation residue conditioner according to claim 4, wherein the shifting body of the shifting and decompacting unit only extends over a partial section of the deposit surface along the transport direction (X) between a fermentation residue dropping point and a fermentation residue removal point.

6. The fermentation residue conditioner according to claim 1, wherein the shifting and decompacting unit is movable along the transport direction (X).

7. A fermentation residue conditioner for conditioning an aggregate material consisting of at least one of a fermentation residue with high water content, a sludge with high water content, and an organic residual mass with low water content, the fermentation residue conditioner defining a fermentation residue dropping point for introducing the aggregate material, and a fermentation residue removal point for removing the aggregate material, the fermentation residue conditioner configured to transport the aggregate material through the fermentation residue conditioner, the fermentation residue conditioner comprising:
a ventilation unit;
a conveyor chain;
a deposit surface for supporting the aggregate material from the underside;
a heating unit for heating the aggregate material supported by the deposit surface, the heating unit in thermal communication with the deposit surface for direct heat conduction to the aggregate material;
a transport element attached to the conveyor chain, configured for protruding into and engaging the aggregate material and moving the aggregate material in a transport direction (X) relative to the deposit surface, and configured such that the transport element does not protrude into the aggregate material by more than 60 mm relative to the deposit surface;
a shifting and decompacting unit for at least one of shifting, loosening, macerating, and homogenizing the aggregate material supported by the deposit surface and moved through the fermentation residue conditioner via the conveyor chain;
the deposit surface having at least a first deposit element positioned beneath the conveyor chain and coupled to the heating unit for providing the direct heat conduction to the aggregate material; and
the deposit surface having at least a second deposit element being coupled to the ventilation unit for ventilating the aggregate material.

8. The fermentation residue conditioner according to claim 7, wherein the conveyor chain comprises a plurality of transport elements, wherein gaps are present between respective transport elements.

9. The fermentation residue conditioner according to claim 8, wherein the conveyor chain is made from metal.

10. A method of conditioning a fermentation residue via a fermentation residue conditioner, the container having a deposit surface for depositing aggregate material and a conveyor chain movable in a transport direction (X) relative to the deposit surface, the method comprising:
depositing aggregate material on the deposit surface of the fermentation residue conditioner;
applying direct conduction heating, via a heating unit, from underneath the conveyor chain to at least a portion of the aggregate material supported by the deposit surface, the heating unit in thermal communication with the deposit surface for direct heat conduction to the aggregate material;
moving the aggregate material with the conveyor chain, which provides a force to an underside of the aggregate material such that the aggregate material is directly transported through the fermentation residue conditioner in said transport direction (X);
ventilating the aggregate material with a ventilation unit as the aggregate material is transported through the fermentation residue conditioner for a subsequent aerobic treatment; and
applying at least one of shifting, loosening, macerating, and homogenizing, via a shifting and decompacting unit, to a portion of the aggregate material as the aggregate material is transported through the fermentation residue conditioner.

11. The method of claim 10, further comprising providing a transport element attached to the conveyor chain, the transport element configured for engaging the aggregate material and moving the aggregate material in a transport direction (X), and the transport element also configured such that the transport element protrudes into the aggregate material by no more than 60 mm relative to the deposit surface.

12. The method of claim 11, wherein the transport element protrudes into the aggregate material by no more than 40 mm.

13. The method of claim 10, wherein ventilating the aggregate material further comprises ventilating the aggregate material with preheated and/or circuit-guided air.

14. The method of claim 10, wherein the conveyor chain is made from metal.
